(19) United States
(12) Patent Application Publication
(10) Pub. No.: US 2024/0157536 A1
(43) Pub. Date: May 16, 2024

(54) MULTI-SPEED GEAR TRAIN FOR POWER TOOL

(71) Applicant: Snap-on Incorporated, Kenosha, WI (US)

(72) Inventors: Jack H. Stickney, Kenosha, WI (US); David A. Cyborski, Kenosha, WI (US)

(73) Assignee: Snap-on Incorporated, Kenosha, WI (US)

(21) Appl. No.: 17/985,707

(22) Filed: Nov. 11, 2022

(51) Int. Cl. B25F 5/00; B25B 21/00

(52) U.S. Cl. CPC B25F 5/001; B25B 21/004

(57) ABSTRACT

A power tool, such as a cordless power ratchet, with a multi-speed gear train is described. A gearbox may use a planetary gearset with a shifting ring gear coupled with a set of compound gears that allows the user to change the output speed of the tool by altering the total gear ratio of the gearbox. A first stage may include a planetary gearset with a shifting ring gear. A second stage may include a set of compound gears whose output connects to the tool's driving mechanism. The exemplary gearbox may allow the user more control over the output during tool operation. A cordless ratchet with a multi-speed geartrain may allow the user to generate high levels of torque to remove a fastener (i.e., making the tool operate at a lower speed), and allow the user to remove the fastener quicker by increasing the speed of the tool.

### TECHNICAL FIELD OF THE INVENTION

The present invention relates generally to a power tool, more particularly to a multi-speed gear train for a power tool, such as a cordless ratchet power tool.

### BACKGROUND OF THE INVENTION

Traditionally, cordless ratchets operate with a single speed, which corresponds to the maximum output torque that the tool can produce. Currently, powered ratchet tools do not allow a user to change the ratio between speed and torque of the output lug because the tools operate under a single gear reduction with a single gear ratio. Current powered ratchet tools also do not provide a user versatility to both remove stubborn fasteners (e.g., with increased torque) and then remove those same fasteners quickly once “broken” (e.g., with high speed). Thus, current powered ratchets restrict the user from obtaining both high speed and high torque. Further, existing cordless ratchets do not have a speed selection gearbox, providing a user with a selection of multiple combinations of speeds and/or torque amounts.

### SUMMARY OF THE INVENTION

The present invention relates broadly to a power tool, such as, for example, a cordless power ratchet, with a multi-speed gear train. According to an embodiment of the present invention, a 2-stage gearbox for a cordless power tool may use a planetary gearset with a shifting ring gear coupled to a set of compound gears that allows a user to selectively change the output speed and/or torque of the output of the tool. According to an embodiment, a cordless ratchet with a multi-speed geartrain may allow a user to generate high levels of torque to remove a difficult fastener (i.e., making the tool operate at a lower speed) by changing the gear ratio to a larger gear reduction, and allow the user to remove the fastener quicker by increasing the speed of the tool once the fastener is “broken” (loosened from its original, tightened state) by changing the gear ratio to a smaller gear reduction.

According to an embodiment, the present invention relates to a multi-speed gearbox for driving a power tool. The gearbox may include a first stage gear assembly including first gears coupled to a first carrier and a ring gear. A second stage gear assembly may include second gears operatively coupled to a stationary plate and a pinion. A switching element may be coupled to the ring gear. The switching element may be configured to selectively move the ring gear between first and second positions. The first position may include the ring gear operatively coupled to the first gears. The second position may include including the ring gear operatively coupled to the first gears and first carrier.

According to another embodiment, the present invention relates to a multi-speed power tool. The power tool may include a housing and a driver portion coupled to the housing and adapted to drive a work piece. A motor, such as, for example, a brushless direct current (BLDC) motor, may be disposed within the housing along with a gearbox operatively coupled to the motor and the driver portion. The gearbox may include a first stage gear assembly including first gears coupled to a first carrier and a ring gear. A second stage gear assembly may include second gears operatively coupled to a stationary plate and a pinion. A switch may be coupled to the ring gear and configured to selectively move the ring gear between first and second positions. The first position may include the ring gear operatively coupled to the first gears. The second position including the ring gear operatively coupled to the first gears and first carrier.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an exemplary power tool, such as a motorized ratchet tool, according to an embodiment of the present invention.

FIG. 2 is block diagram representing an exemplary power tool, according to an embodiment of the present invention.

FIG. 3 is a block diagram representing a gearbox, according to an embodiment of the present invention.

FIG. 4 is an exploded view of components of a gearbox, according to an embodiment of the present invention.

FIG. 5A is a perspective view of the components of a gearbox in a low-speed configuration, according to an embodiment of the present invention.

FIG. 5B is a perspective view of the components of a gearbox in a high-speed configuration, according to an embodiment of the present invention.

FIG. 6 is block diagram representing an alternative configuration of a gearbox, according to an embodiment of the present invention.

### DETAILED DESCRIPTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention but is instead used to discuss exemplary embodiments of the invention for explanatory purposes only.

The present invention relates broadly to a power tool, such as, for example, a cordless power ratchet, with a multi-speed gear train. According to an embodiment of the present invention, a gearbox for a cordless ratchet may use a planetary gearset with a shifting ring gear coupled with a set of compound gears that allows the user to selectively change the output speed and/or torque of the output of the tool, such as, for example, a ratchet lug. In any embodiment, the present invention may include a 2-stage gearbox. A first stage may include a planetary gearset with a shifting ring gear. The second stage may include a set of compound gears whose output connects to the tool's crankshaft. In any embodiment, these stages may be configured in a reverse order, such that the planetary gearset occurs after the set of compound gears. The exemplary gearbox allows a user more control over the tool's output speed and/or torque during tool operation. According to an embodiment, a cordless ratchet with a multi-speed geartrain allows a user to generate high levels of torque to loosen a difficult fastener (i.e., making the tool operate at a lower speed), and then allow the user to remove the fastener quicker by increasing the speed of the tool (i.e. consequently lowering the torque output of the tool) once the fastener has been “broken.”

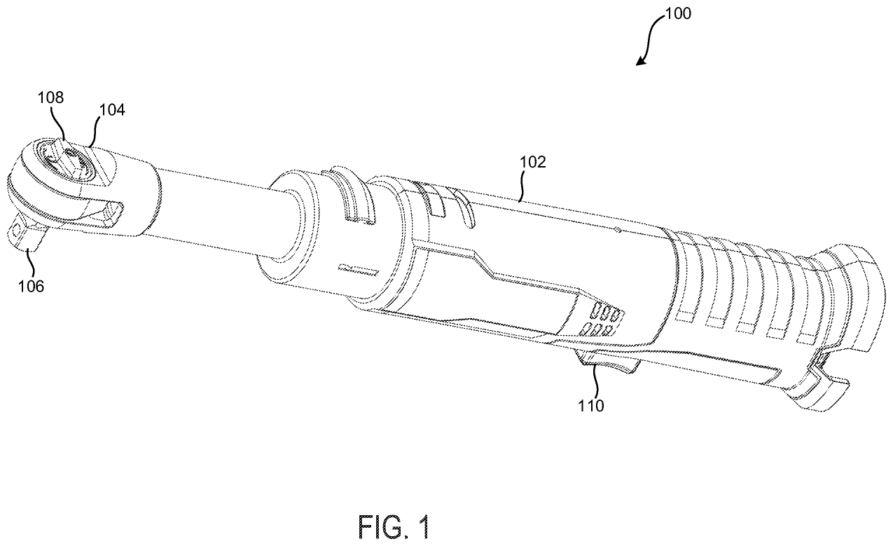

Referring to FIG. 1, an exemplar power tool 100, such as, for example, a motorized hand-held ratcheting tool, such as a cordless power ratchet wrench, drill, and/or driver, driven by an electric power source, includes a housing portion 102 adapted to be held by a user and a driver portion 104 coupled to the housing portion 102. The driver portion 104 is adapted to apply torque to a work piece, and may include a drive lug 106 adapted to engage a tool (e.g., socket or bit) to drive the work piece, for example, in a well-known manner. The drive lug 106 is operatively coupled to and driven by an electric motor (not shown), such as a BLDC motor, via a ratcheting mechanism of the driver portion 104, described below. The driver portion 104 may also include a selector lever 108 adapted to select a desired rotational drive direction of the drive lug 106 (i.e., clockwise or counterclockwise), as described below. For example, the driver portion 104 may be a ratchet head of a ratchet tool, and may include a crankshaft and other rotary components to transmit torque through a ratcheting technique.

The housing portion 102 operably houses components of the tool 100, such as, for example, one or more of the motor adapted to drive the drive lug 106, a trigger 110 adapted to actuate the motor, a power source (not shown) adapted to provide power for the motor, such as, for example, a battery, and/or a display assembly (not shown). In an embodiment, the housing portion 102 is assembled from two or more clamshell housing portions coupled together to cooperatively form the housing portion 102 and couple to the driver portion 104, thereby enclosing the components within the housing portion 102. The housing portion 102 may also include or form a grip for a user to hold during operation of the tool 100.

The motor can be operably coupled to the power source via the trigger 110 in a well-known manner. The power source can be external (e.g., an electrical wall outlet, generator, external battery, etc.) or internal (e.g., a removable and/or rechargeable battery). The trigger 110 can be adapted to selectively cause the motor to be turned ON and OFF, or cause electric power/voltage to flow from the power source to the motor or cease flow from the power source to the motor.

The trigger 110 can be an actuation mechanism that employs a push button type actuator or other type of actuator. For example, the user can depress the trigger 110 inwardly to selectively cause power to be drawn from the power source and cause the motor to provide torque to the driver portion 104 in a desired rotational direction. It will be appreciated that any suitable trigger 110 or switch can be implemented without departing from the spirit and scope of the present invention. For example, the trigger 110 can be a toggle actuator, a touch sensitive actuator, a slide actuator, or other suitable actuator or device. In another example, the trigger 110 can be biased outwardly, such that the trigger 110 is inwardly depressible, relative to the housing portion 102, to cause the tool 100 to operate, and releasing the trigger 110 causes the trigger 110 to biasly move outwardly, relative to the housing portion 102, to cease operation of the tool 100 via the biased nature of the trigger 110. The trigger 110 may also be a variable speed type mechanism. A speed selection switch (not shown) may also be operatively incorporated into the tool 100 such that actuation of the switch activates a change in a gearbox or the like of the tool 100 to toggle between two or more speeds, as explained below.

In an embodiment, the tool 100 may include a display assembly adapted to indicate tool information to a user. The tool information can include, for example, status of the tool, such as, for example, a power level of the power source, a selected driving direction of the drive lug 106, a speed selection, a power state of the motor, battery charge or condition, output torque of the tool 100, etc. The display assembly may include one or more buttons and/or touch sensitive areas adapted to receive a user input, such as, for example, selecting what is displayable on the display, for selecting tool parameters, such as, for example, the tool speed, torque output, and/or for otherwise manipulating the display to control the tool 100 and/or parameters of the tool 100.

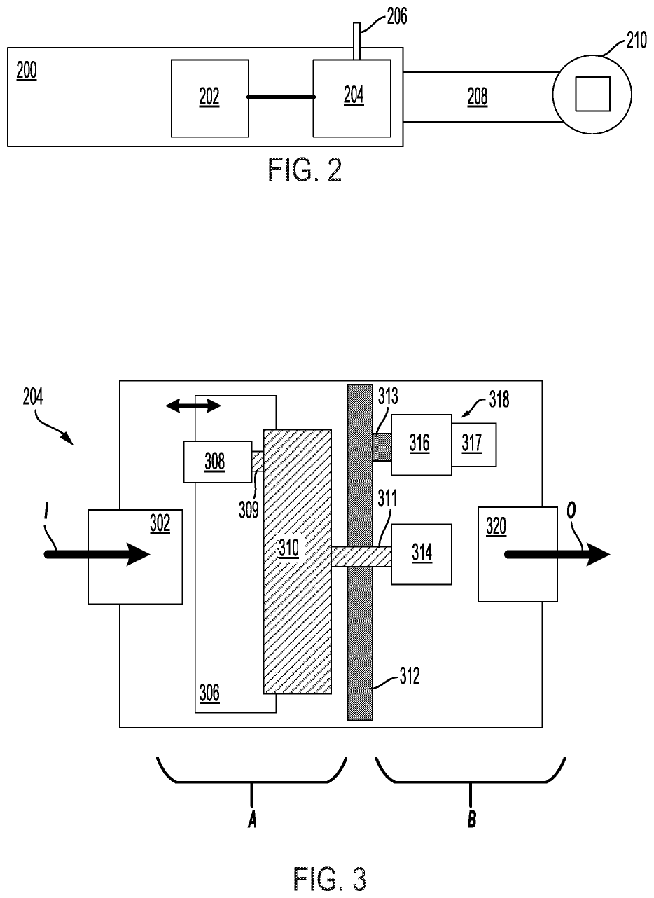

Referring to FIGS. 2-5B, an exemplar power tool 200 and its components incorporating an embodiment of the present invention are generally depicted in conceptual block diagrams. It will be appreciated that any of the components described in connection with the tool 200 may be incorporated into and/or implemented in the tool 100. According to an embodiment, the power tool 200 may include, among others, a motor 202, a gearbox 204, a speed toggle switch 206, a driver portion 208 (which may include a crankshaft) and an output 210, such as a square head and/or ratchet mechanism. The motor 202, as detailed above, may be operatively coupled to a power source that drives the motor 202 to rotate a shaft which is operatively coupled to the gearbox 204. The gearbox 204 may include one or more stages comprised of one or more gear assemblies that, when driven by the motor 202, cause the rotation of the crankshaft 208 and consequently rotation, or other activation, of the output 210 of the tool.

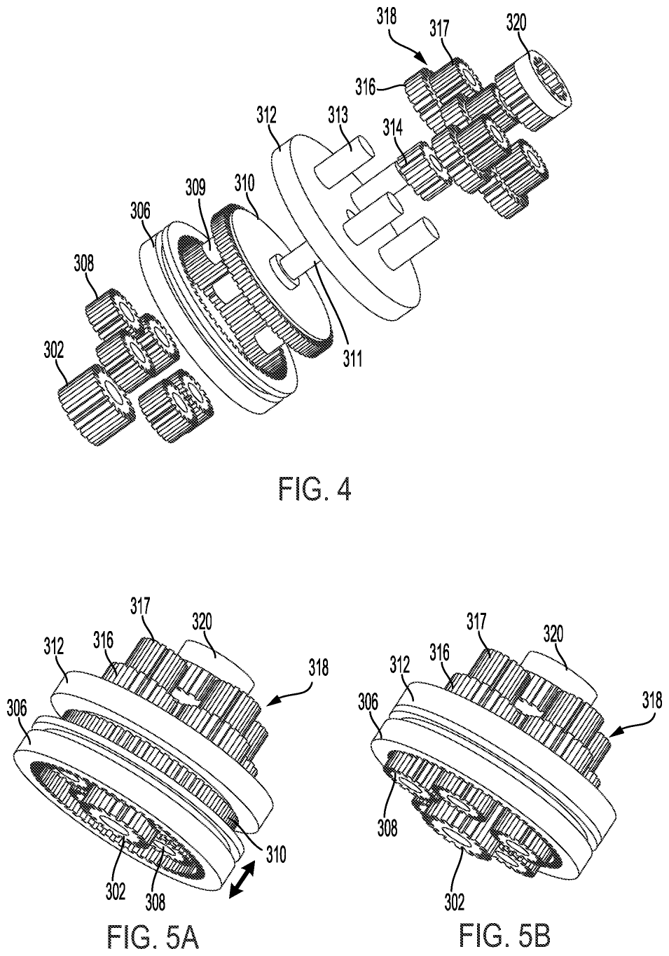

In an embodiment, the gearbox 204 may be or include a variable speed gearbox, encased for example in a plastic or metal housing, comprising one or more stages of gear assemblies. The gearbox 204 may be incorporated or implemented in either of the tools 100 and 200. FIG. 3 depicts a conceptual block diagram of the gearbox 204, and FIGS. 4-5B illustrate components of the gearbox 204. According to an embodiment, the gearbox 204 provides a user with the ability to alter the tool's output speed and/or the tool's output torque. The gearbox 204, in an embodiment, may include two stages: one stage (A) (also referred to as a first stage gear assembly) that includes a first planetary gearset 308 operatively coupled to an input gear 302 driven by an input (I) from a motor (such as the motor 202). The first planetary gears 308 may be operatively coupled with a ring gear 306 that is movable axially within the gearbox 204 between first and second positions to implement the speed-changing mechanism in the tool. The planetary gears 308 may be coupled to a carrier 310 by pins 309. According to an embodiment, the pins 309 are substantially equidistantly spaced about the center axis. One of skill in the art will appreciate that the number of planetary gears may be varied according to the desired gear ratio. As such, the angle between the pins is variable, depending on the number of planet gears. The angle between the gears, according to an embodiment may be about 360° divided by the number of pins.

The carrier 310 may include or define outwardly facing teeth sized and shaped to meshingly engage internally facing teeth of the ring gear 306. The tooth profile of the carrier teeth and planet gear teeth for which the movable ring gear engages may have differing tooth profiles or substantially the same tooth profiles. A output shaft 311 that is operatively coupled to the planetary carrier 310 may pass through a stationary plate 312 to operatively couple with a pinion 314 that drives the rotation of a second stage (B) (also referred to as a second stage gear assembly).

Stage (B) includes the pinion 314 operatively coupled to a set of compound gears 318 coupled to pins 313 of the stationary plate 312. Like the pins 309 of the first stage carrier 310, the pins 313 of the stationary plate 312 may vary in number according to the desired gear ratio, with each of the pins spaced equidistant about the plate. According to an embodiment, stage (B) may not include a ring gear like that of stage (A). The compound gears 318 may be comprised of individual gears 316 and 317 fixedly coupled together. The compound gears 318 may provide a constant gear reduction to an output coupling 320 that will be connected to the tool's crankshaft (O), such as the driver portion 208. The output from the compound gear stage may alternatively be a crankshaft fitted to mesh with the compound gears, removing the necessity for the output coupling 320.

The compound gears are used to create lower ratios that are not generally possible via planetary gearsets. Thus, when the planetary gearset is activated to create a lowest possible reduction (such as, for example, 7:1), the speed of the tool will not be too low so as to cause usability issues.

According to an embodiment, the speed or torque selection may be controlled by the user through a physical toggle switch (such as the speed toggle switch 206), or other switching element, on the body of the tool (such as tool 100 and/or tool 200). The movable ring gear 306 may control the speed-changing/torque-changing mechanism, such that when the ring gear 306 is disposed in the first position, the ring gear 306 is only engaged with the planetary set's planet gears 308, as shown in FIG. 5A, the gearbox provides a planetary reduction. In an example, a low-speed, planetary reduction configuration may yield a gear ratio of about 8:1.

When the ring gear 306 is disposed in the second position, the ring gear 306 is shifted to merge with both the planet gears 308 and the carrier 310 of the planetary set, as shown in FIG. 5B, the planetary gear reduction attribute of the gearset is removed and, in an example, creates a 1:1 ratio through the stage (A). Stage (B) may be included to provide a lower gear reduction than a planetary gearset through the stage. In an example, the total gear ratio for a high-speed configuration may be about 3.6:1. It will be appreciated that any different gear ratios may be used without departing from the scope and spirit of the present invention.

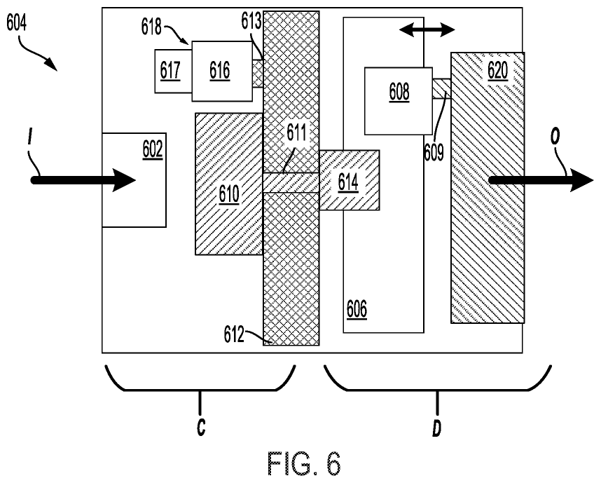

Referring now to FIG. 6, an alternate gearbox 604 is conceptually depicted, which may be incorporated or implemented in the tools 100 and/or 200. This alternate configuration depicts a “reverse” configuration from FIG. 3, described below. In the gearbox 604, the first stage (C) includes a in input (I) applied to an input gear 602 operatively coupled to a compound gearset 618 formed from gears 617 and 616. A second stage (D) features a planetary set 608 and moveable ring gear 606. The compound gears 618 may be coupled to a stationary plate 612 through the pins 613. The compound gears may also be operatively coupled to a first central gear 610. The first central gear 610 may be coupled to a second central gear (i.e. pinion) 614 by a shaft 611. The second central gear 614 may be operatively coupled to the planetary gearset 608, which in turn, are coupled to an output carrier 620 by pins 609. The output carrier 620 may drive an output (O) of a crankshaft.

The moveable ring gear 606 may be selectively shifted in an axial direction to toggle between first and second positions to provide two speed configurations. In a first low-speed configuration, i.e., first position, the ring gear 606 is only coupled to the planetary gearset 608 a planetary reduction occurs. In general, the planetary gearset ratios are higher than 3:1. In an example, the low-speed gear ratio of stage (C) is about 1.5:1 (preferably 1.6:1) and stage (D) is about 4:1 (preferably 4.25:1) with a total gear ratio of the gearbox 604 is about 7:1 (preferably 6.8:1).

When the ring gear 606 is toggled to the second position, the ring gear 606 engages the output carrier 620, and the planetary attribute is removed. In the second position, stage (D) creates a 1:1 gear ratio, for example. In such a configuration, a high-speed configuration, the total gear ratio is about 1.5:1 (preferably 1.6:1). It will be appreciated that any different gear ratios may be used without departing from the scope and spirit of the present invention.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

As used herein terms denoting direction, order, or orientation such as “first,” “second,” “horizontal,” “vertical,” “lateral,” “top,” “bottom,” “left,” “right,” “over,” “under,” “above,” “below,” “front,” back,” or the like, are non-limiting and used herein for ease of explanation. One of skill in the art will recognize the use of these terms as merely descriptive examples that do not limit the placement, orientation, or disposition of the elements described using such terms.

The matter set forth in the foregoing description and accompanying drawings is offered by way of illustration only and not as a limitation. While particular embodiments have been shown and described, it will be apparent to those skilled in the art that changes, and modifications may be made without departing from the broader aspects of the inventors' contribution. The actual scope of the protection sought is intended to be defined in the following claims when viewed in their proper perspective based on the prior art.

What is claimed is:

1. A multi-speed gearbox for a power tool, the gearbox comprising:
a first stage gear assembly including first gears operatively coupled to a first carrier, and a ring gear;
a second stage gear assembly including second gears operatively coupled to a pinion; and
a switch coupled to the ring gear and configured to selectively move the ring gear between first and second positions, the first position including the ring gear operatively coupled to the first gears and the second position including the ring gear operatively coupled to the first carrier and the first gears.

2. The gearbox of claim 1, wherein the first gears includes planetary gears.

3. The gearbox of claim 1, wherein the second set of gears includes compound gears.

4. The gearbox of claim 1, further comprising an input gear operatively coupled to the first gears.

5. The gearbox of claim 4, wherein the input gear is operatively coupled to a motor.

6. The gearbox of claim 1, further comprising an output gear operatively coupled to the second gears.

7. The gearbox of claim 6, wherein the output gear is operatively coupled to a driver portion.

8. The gearbox of claim 7, wherein the output gear is operatively coupled to a crankshaft of the driver portion.

9. The gearbox of claim 1, further comprising an input gear operatively coupled to the second set of gears.

10. The gearbox of claim 9, further comprising an output gear operatively coupled to the first gears.

11. The gearbox of claim 1, wherein the first stage gear assembly has a gear ratio of 1:1 when the ring gear is in the second position.

12. The gearbox of claim 1, wherein the first stage gear assembly has a gear ratio of about 3.6:1 when the ring gear is in the first position.

13. The gearbox of claim 1, wherein the second stage gear assembly has a gear ratio of about 2.2:1.

14. The gearbox of claim 1, wherein the first stage gear assembly has a gear ratio of about 4.25:1 when the ring gear is in the first position.

15. The gearbox of claim 1, wherein the second stage gear assembly has a gear ratio of about 1.6:1.

16. A multi-speed power tool, comprising:
a housing;
a driver portion coupled to the housing and adapted to drive a work piece;
a motor disposed within the housing; and
a gearbox disposed in the housing and operatively coupled to the motor and the driver portion, the gearbox including:
a first stage gear assembly including first gears coupled to a first carrier and a ring gear;
a second stage gear assembly including second gears operatively coupled to a pinion; and
a switch coupled to the ring gear, the switch configured to selectively move the ring gear between first and second positions, the first position including the ring gear operatively coupled to the first gears and the second position including the ring gear operatively coupled to the first carrier and the first gears.

17. The power tool of claim 16, wherein the first gears includes planetary gears.

18. The power tool of claim 16, wherein the second set of gears includes compound gears.

19. The power tool of claim 16, further comprising an input gear operatively coupled to the first gears.

20. The power tool of claim 19, wherein the input gear is operatively coupled to the motor.

21. The power tool of claim 16, further comprising an output gear operatively coupled to the second gears.

22. The power tool of claim 21, wherein the output gear is operatively coupled to the driver portion.

23. The power tool of claim 16, further comprising an input gear operatively coupled to the second set of gears.

24. The power tool of claim 23, further comprising an output gear operatively coupled to the first gears.

25. A power ratchet tool, comprising:
a housing;
a ratchet head coupled to the housing and adapted to drive a work piece;
a motor disposed within the housing; and
a gearbox disposed in the housing and operatively coupled to the motor and the ratchet head, the gearbox including:
a first stage gear assembly including first gears coupled to a first carrier and a ring gear;
a second stage gear assembly including second gears operatively coupled to a pinion and the ratchet head; and
a switch coupled to the ring gear, the switch configured to selectively move the ring gear between first and second positions, the first position including the ring gear operatively coupled to the first gears and the second position including the ring gear operatively coupled to the first carrier and the first gears.
